(19) United States
(12) Patent Application Publication
(10) Pub. No.: US 2017/0226942 A1
(43) Pub. Date: Aug. 10, 2017

(54) COMPRESSOR UNIT AND METHOD FOR OPERATING THE SAME

(71) Applicant: GARDNER DENVER DEUTSCHLAND GMBH, Bad Neustadt an der Saale (DE)

(72) Inventor: Andreas Denner, Kisselbach (DE)

(21) Appl. No.: 15/504,610

(22) PCT Filed: Aug. 14, 2015
(86) PCT No.: PCT/EP2015/068754

§ 371 Date: Feb. 16, 2017

(30) Foreign Application Priority Data
Aug. 19, 2014 (DE) 10 2014 111 835.9

(51) Int. Cl. F02D 41/00; F02D 41/04; F02B 37/16; B60K 13/02; F02B 37/00

(52) U.S. Cl. CPC F02D 41/0007; B60K 13/02; F02B 37/004; F02B 37/16; F02D 41/042; F02D 2200/0406; F02D 2200/101

(57) ABSTRACT

The present invention relates firstly to a method for operating a compressor powered by an internal combustion engine for compressing air. Furthermore, the invention relates to a compressor, which is suitable for executing the method according to the invention. A first turbocharger for supplying pre-compressed air to the internal combustion engine is disposed in an exhaust flow of the internal combustion engine. Furthermore, a second turbocharger for pre-compression of the air to be compressed by the compressor is disposed in the exhaust flow of the internal combustion engine. The method according to the invention first comprises a step in which a monitoring of a pressure of the pre-compressed air generated by the first turbocharger occurs during an operating state of the compressor. In a further step of the method, a termination of the operating state occurs as soon as the monitored pressure falls below a previously determined value.

The present invention relates firstly to a method for controlling the drive of a compressor unit powered by an internal combustion engine, for compressing or pressurizing air or gas. The method is designed in particular for treatment of a malfunction. The invention further relates to a compressor unit that is suitable for executing the method according to the invention.

DE 40 32 451 A1 teaches of a device for regulating the boost pressure of an internal combustion engine. The device comprises a boost pressure sensor at the high pressure side.

A device for generating compressed air having at least two turbine powered compressor units is known from WO 00/32916 A1.

U.S. Pat. No. 4,496,291 shows a turbocharger system for an internal combustion engine having numerous turbine component connected in series.

GB 1 441 498 describes a compressor equipped with a turbocharger.

An internal combustion engine having two turbochargers and one regulator for regulating the first and/or second turbocharger is known from DE 10 2012 019 896 A1.

DE 10 2008 061 399 A1 shows an internal combustion engine having two exhaust turbochargers connected in series. The exhaust turbochargers each comprise one exhaust turbine in an exhaust line and one compressor in an air intake.

DE 199 60 152 A1 teaches of a compressor system for generating compressed air in which a compressor is powered by an internal combustion engine. A first exhaust turbocharger is disposed at the exhaust side of the internal combustion engine, which supplies the internal combustion engine with pre-compressed air. Furthermore, a second exhaust turbocharger is disposed at the exhaust side of the internal combustion engine, which supplies pre-compressed air to a fluid injected displacement device compressor. The first exhaust turbocharger and the second exhaust turbocharger are disposed in series.

The object of the present invention is to prevent damage to the second turbocharger in a compressor unit equipped with an internal combustion engine and two turbochargers, resulting from a malfunction in a compressor unit.

This object is achieved by a method in accordance with Claim 1 as well as a compressor unit in accordance with the coordinate independent Claim 14.

The method according to the invention is used for operating or controlling the drive of a compressor unit (also referred to below in short as a compressor) driven by an internal combustion engine for compressing air or gas. In particular, the method should treat a possible malfunction thereby, in order to prevent damage to the compressor. The compressor is used to compress air, in order to make said air available in the form of compressed air. Because the compressor is powered by an internal combustion engine, it is preferably designed as a transportable unit.

At least one first turbocharger for supplying compressed (thus, initially pre-compressed) air to an internal combustion engine is disposed in an exhaust flow path (also referred to below in short as the exhaust flow) of the internal combustion engine. The turbocharger thereby is thus an exhaust turbocharger. The (pre-) compressed air is supplied to a combustion chamber of the internal combustion engine. The first turbocharger serves to increase the power or efficiency of the internal combustion engine.

Furthermore, at least one second turbocharger for compression (initially thus pre-compression) of the air to be compressed by the compressor is disposed in the exhaust flow of the internal combustion engine. The second turbocharger is thus likewise an exhaust turbocharger, wherein the (pre-) compressed air from the second turbocharger is not supplied to the internal combustion engine, but rather, is discharged as compressed air in the form of pressurized air after at least one further compression procedure. For this reason, the second turbocharger is preferably disposed downstream of a main compressor.

The first turbocharger and the second turbocharger are preferably connected in series in the exhaust flow path.

The method according to the invention first comprises a step in which a monitoring of a pressure of the pre-compressed air generated by the first turbocharger occurs during an operating state of the compressor. Thus, an actual pressure of the pre-compressed air is monitored, which air flows into the combustion chamber of the internal combustion engine, wherein measurement values of the pressure generated by the first turbocharger represent monitoring data, and preferably form an actual-characteristic. Accordingly, a target-characteristic is preferably also predefined. The standard monitoring data of the first turbocharger, which comprise at least the measurement values for the pressure generated by the first turbocharger, are transmitted to a superordinate compressor control system. This transmission preferably occurs during all of the operating states of the downstream main compressor. The pressure is preferably measured immediately prior to the inflow of the pre-compressed air into the combustion chamber. In the operating state, the compressor generates the compressed air in the form of pressurized air, such that the internal combustion engine does not only run at an idle.

In a further step of the method according to the invention, a changing or termination of the operating state occurs as soon as the monitored pressure falls below a predefined value. A comparison of the actual-characteristic with the target-characteristic preferably occurs for this, which is preferably carried out in the superordinate compressor control system. It is determined with this comparison whether the actual-characteristic deviates from the target-characteristic over the entire operating range, or at individual, previously specified operating points for a minimum period by more than a predefined value. The changing of the operating state preferably results in the two turbochargers no longer compressing air, or compressing air only to an insignificant extent. The changing or terminating of the operating state preferably leads to a standby state in which the internal combustion engine is running in idle, for example.

A particular advantage of the method according to the invention is that it is possible to monitor the correct functioning of the components connected downstream of the second turbocharger by means of a simple monitoring of the pressure generated by the first turbocharger, in order to prevent damage to the second turbocharger. The present invention is based on the surprising discovery that an overload to the second turbocharger can also be determined at the first turbocharger, where the pressure can be determined with little effort and without difficulty, while determining the pressure at the second turbocharger is problematic due to necessary adaptation to different environmental conditions.

The second turbocharger preferably does not have a measurement sensor for monitoring a reliable operating range, and as a result, is passively controlled by the first turbocharger for diagnosis and monitoring of the system, because a flow dependence established in the common exhaust flow is exploited for this. Thus, there is no measurement of a pressure generated by the second turbocharger, or of another operating variable of the second turbocharger.

The pressure monitored at the first turbocharger falls below the previously determined value in particular then, when a volume subjected to the pre-compressed air by the second turbocharger is closed off due to a malfunction, which leads to an overload to the second turbocharger. In the case of this malfunction, the second turbocharger acts against a closed system. If the malfunction persists, the second turbocharger will reach its pump capacity limit. Significant pressure pulsations and oscillations are created by the pumping. The temperature of the second turbocharger is increased significantly, and this ultimately results in damage to the second turbocharger. In accordance with the invention, however, the malfunction cannot persist, because the operating state of the compressor is terminated, such that the pre-compression of the air by the first turbocharger and the second turbocharger stops, at least substantially, and the pressure in the volume subjected to the pre-compressed air from the second turbocharger decreases. The specified malfunction occurs in particular then, when a blow-off device for discharging the volume does not open due to a malfunction.

The air that has been pre-compressed by the second turbocharger is preferably supplied to the main compressor when in the operating state, which compresses the pre-compressed air such that it can be discharged as pressurized air. The main compressor is powered by an internal combustion engine, and is preferably formed by a screw compressor.

The step for terminating the operating state, as soon as the monitored pressure falls below a predefined value preferably also comprises a closing of an intake air supply to the main compressor, such that the main compressor is not loaded.

The pre-compressed air from the second turbocharger is preferably supplied to the main compressor via an intake regulator when in the operating state. The intake regulator is open during operation, such that the pre-compressed air can flow to the main compressor. In other states, the intake regulator is closed, such that no intake air can flow to the main compressor, and the main compressor is not loaded. The step for stopping the operating state as soon as the monitored pressure falls below a predefined value preferably also comprises an activation of the intake regulator for closing the intake regulator. Even if the intake regulator is already closed due to the malfunction, it is ensured that the intake regulator is closed through the activation of the intake regulator for closing the intake regulator, and the main compressor is not loaded.

The operation of the compressor in order to reach the operating state preferably starts with a start-up phase. The internal combustion engine is accelerated from a standstill to a low rotational rate during the start-up. The low rotational rate represents a gentle rotational rate, and is significantly lower than an operating rotational rate of the internal combustion engine. The low rotational rate is at least as high as an idling rotational rate. The intake regulator is open during the start-up.

The transition from the start-up procedure to the operating state preferably does not occur immediately, but rather via a warm-up phase. The internal combustion engine continues to run at the low rotational rate during the warm-up phase. The intake regulator is closed. In order to not entirely close the volume subjected to pre-compressed air from the second turbocharger when the intake regulator is closed, a pressure relief or blow-off device is opened, such that air can escape from this volume via the blow-off device.

In the transition from the warm-up phase to the operating state, the internal combustion engine is accelerated to the operating rotational rate, while the blow-off device is closed and the intake regulator is opened.

The malfunction specified above occurs in particular when the blow-off device is not properly opened, while the intake regulator remains closed. The blow-off device can remain in the closed state in particular when a control line controlling the blow-off device is blocked, e.g. when said control line is frozen.

The previously determined value of the pressure generated by the first turbocharger, the falling below of which leads to a termination of the operating state, is preferably dependent on a rotational rate of the internal combustion engine. Thus, a function of the previously determined pressure is given by the rotational rate, e.g. in the form of a characteristic curve. Thus, not merely a single value, but rather a series of values is determined in advance. Accordingly, the rotational rate of the internal combustion engine is permanently, or at least periodically, measured during the operating state, in order to be able to select the respective previously determined value for the measured rotational rate, and in order to be able to compare this value with the currently measured value of the pressure of the pre-compressed air generated by the first turbocharger.

The function of the previously determined pressure from the rotational rate is preferably increasing, such that the previously determined value increases with the rotational rate.

The termination or changing of the operating state preferably comprises a lowering of the rotational rate of the internal combustion engine from the operating rotational rate to an idling rotational rate of the internal combustion engine. The idling rotational rate of the internal combustion engine is significantly lower than the operating rotational rate of the internal combustion engine. The idling rotational rate of the internal combustion engine is preferably only a fraction of the operating rotational rate of the internal combustion engine.

The termination or changing of the operating state preferably first comprises the lowering of the rotational rate of the internal combustion engine from the operating rotational rate to the idling rotational rate of the internal combustion engine, and subsequently a shutting off of the internal combustion engine, by means of which it ultimately comes to a standstill.

The termination or changing of the operating state furthermore preferably comprises a storing of the occurring malfunction in an error memory and/or a reporting of the malfunction to a user.

The activation of the blow-off device preferably occurs pneumatically via a pressure regulator. The pressure regulator is formed by an electronic proportional regulator, for example. The pressure regulator is preferably subjected to the pressurized air generated by the main compressor, the pressure of which is reduced by the potential removal of pressurized air. The intake regulator is preferably also controlled via the pressure regulator. The control pressure caused by the pressure regulator is preferably monitored. If the control pressure exceeds a maximum previously determined value when in the operating state, then the operating state is preferably terminated. This termination of the operating state preferably occurs in the same manner as the termination of the operating state as soon as the pressure of the pre-compressed air generated by the first turbocharger falls below the previously determined value.

In preferred embodiments of the method according to the invention, the exhaust flow of the internal combustion engine initially flows through the first turbocharger and subsequently through the second turbocharger. In this manner, a series connection of the two turbochargers is formed.

The internal combustion engine is preferably formed by a diesel engine.

The compressor according to the invention serves to compress air, which is then provided as pressurized air. The compressor has an internal compression engine for powering the compressor. The compressor furthermore comprises a first turbocharger disposed in the exhaust flow of the internal combustion engine, for supplying pre-compressed air to the internal combustion engine, which flows into a combustion chamber of the internal combustion engine.

The compressor furthermore comprises a second turbocharger disposed in the exhaust flow of the internal combustion engine for pre-compression of the air that is to be pressurized. A further component of the compressor forms a control unit for activating the compressor. This control unit is configured for executing preferred embodiments of the method according to the invention. Moreover, the compressor according to the invention preferably also has such features as those indicated in the context of the method according to the invention.

Further advantages, details and developments of the invention can be derived from the following description of a preferred embodiment of the invention, with reference to the drawings. Therein:

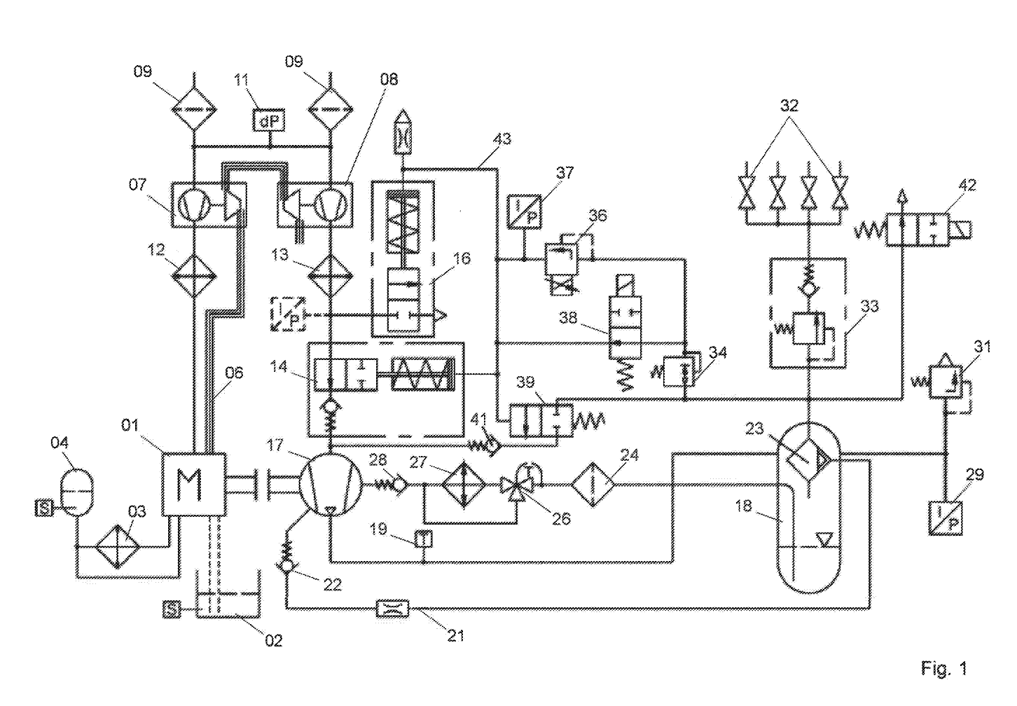

FIG. 1: shows a pneumatic circuit diagram of a preferred embodiment of a compressor according to the invention; and

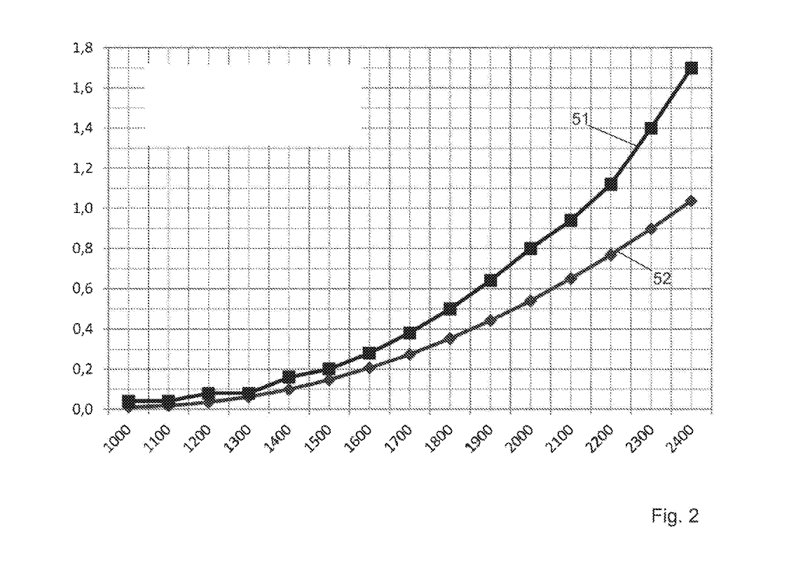

FIG. 2: shows a diagram illustrating the relationship of a minimum pressure to a rotational rate.

FIG. 1 shows a pneumatic circuit diagram of a preferred embodiment of a compressor according to the invention. The compressor comprises a diesel engine 01, which functions as a drive for the compressor. The diesel engine is powered by diesel from a diesel tank 02. The diesel engine is cooled by a water cooler 03. The water cooler 03 is connected to fluid reservoir 04.

An exhaust flow 06 of the diesel engine 01 is first conducted through a first turbocharger 07 and subsequently through a second turbocharger 08. The turbochargers 07, 08 obtain air via two air filters 09, between which a difference pressure switch 11 is disposed. The pre-compressed air from the first turbocharger 07 is cooled with a first air cooler 12, upon which the diesel engine 01 is loaded with the pre-compressed, cooled air.

The pre-compressed air from the second turbocharger 08 is cooled with a second air cooler 13, and subsequently flows to an intake regulator 14 and to a blow-off device 16, wherein normally only one of the two components is open. If the intake regulator 14 is open, the pre-compressed, cooled air flows to a screw compressor 17, which is powered by the diesel engine 01, and serves to compress the pre-compressed air, i.e. for generating the pressurized air that is to be provided. If the intake regulator 14 is closed, the pre-compressed, cooled air flows out via the open blow-off device 16, such that it escapes. As a result, the second turbocharger 08 is prevented from acting on a closed volume, by means of which it could become damaged.

The pressurized air generated by the screw compressor 17 flows into a pressure reservoir 18, wherein the temperature thereof is monitored with a temperature sensor 19. Oil located in the pressure reservoir 18 flows to the screw compressor 17 via an oil filter 24 and via an oil temperature regulator 26 having an oil cooler 27 as well as a non-return valve 28, in order to supply it with oil.

A fine separator 23 is located in the pressure reservoir 18. Oil separated out by the fine separator 23 is then supplied back to the screw compressor 17 via an intake line 21 and via a non-return valve 22.

The pressure in the pressure reservoir 18 is monitored with a pressure sensor 29, and can be reduced with a safety valve 31 when an acceptable pressure has been exceeded.

The pressurized air in the pressure reservoir 18 can be removed at removal taps 32 for the desired application. When the removal taps 32 are fully open, it is then ensured with a pressure-sustaining valve 33 that a residual pressure in the pressure reservoir 18 is maintained, in order to ensure that the screw compressor 17 is always supplied with sufficient oil.

The pressurized air in the pressure reservoir 18 is also conducted to an electronic proportional regulator 36 via a pressure limiter 34. The pressure of the pressurized air regulated by the electronic proportional regulator 36 can be measured with a pressure sensor 37. The pressurized air regulated by the electronic proportional regulator 36 serves to activate the intake regulator 14 and the blow-off device 16.

There is also a quick-action stop valve 38 disposed behind the pressure limiter 34. When idling, i.e. when no pressurized air is removed at the removal taps 32, the intake regulator 14 is closed and the diesel engine 01 rotates at an idling rotational rate, some air is fed to the screw compressor 17 via a bypass valve 39 and via a non-return valve 41, in order to protect the screw compressor 17 when idling. The pressure applied to the pressure limiter 34 can also be relieved at a relief valve 42.

For the start-up of the compressor, the diesel engine 01 is accelerated to a gentle rotational rate starting from a standstill, corresponding to the idling rotational rate. The intake regulator 14 initially remains open until an operating pressure of approx. 1.5 excess pressure has been built up. The intake regulator 14 is subsequently closed by an activation of the proportional regulator 36 and a warm-up phase begins, in which the diesel engine 01 continues to run at the gentle rotational rate. The proportional regulator 36 and the quick-action stop valve 38 are open in this phase. There is therefore a control pressure at the blow-off device 16, such that it opens. As a result, the air conveyed by the second turbocharger 09 can escape into the environment. It then transitions into the operating state after the warm-up phase. Pressurized air is removed at the removal taps 32 when in the operating state. The intake regulator 14 is opened through activation with the proportional regulator 36, while the blow-off valve 16 is closed. As soon as no more air is removed at the removal taps 32, the intake regulator 14 is closed through activation with the proportional regulator 36, while the blow-off device is opened and the diesel engine 01 is run at its idling rotational rate.

In the event of a malfunction, a control line 43 leading from the proportional regulator 36 to the blow-off device 16 is blocked, e.g. when it is frozen. In this case, the blow-off device 16 does not open, while the intake regulator 14 remains closed. Consequently, the second turbocharger 08 subjects a closed volume to pre-compressed air. When in the operating state, the diesel engine 01 runs at the operating rotational rate. The second turbocharger 08 reaches its pump limit, at which point it is overloaded, which leads to damage to the second turbocharger 08.

In accordance with the invention, the actual-pressure generated by the first turbocharger 07 is monitored. A pressure sensor (not shown) directly attached to the diesel engine 01 is used for this. If this pressure drops below a value previously determined as function of the rotational rate of the diesel engine 01 (cf. FIG. 2), then the malfunction described above can be detected according to the invention. In this case, the diesel engine 01 is first brought to its idling rotational rate. As a result, the load to the second turbocharger 08 is substantially lowered, such that damage to the second turbocharger 08 is prevented. At the same time, the intake regulator 15 is activated in order to close it, in order to ensure that it is actually closed. As a result, it is ensured that the screw compressor 17 no longer takes in any air, i.e. it is not loaded, such that the diesel engine 01 can run at its idling rotational rate. After the diesel engine 01 is running at its idling rotational rate, it is shut off, such that it comes to a standstill. The detected malfunction is stored in an error memory.

In addition, the pressure measured with the pressure sensor 37 is monitored. If this pressure exceeds a previously determined maximum value, then this likewise leads to the sequence described above for terminating the operation of the compressor.

FIG. 2 shows a diagram illustrating the dependency of the previously determined minimal value for the pressure generated by the first turbocharger 07 (shown in FIG. 1) on the rotational rate of the diesel engine 01 (shown in FIG. 1). The Y-axis indicates the pressure in bars of excess pressure. The X-axis indicates the rotational rate of the diesel engine 01 in rotations per minute.

A first characteristic curve 51 indicates the pressure generated by the first turbocharger 07 as a function of the rotational rate of the diesel engine 01, when the compressor functions correctly and there is no malfunction.

A second characteristic curve 52 indicates the previously determined minimal value for the pressure generated by the first turbocharger 07 as a function of the rotational rate of the diesel engine 01, which serves in accordance with the invention as a criterion for determining the malfunction. The previously determined minimum value of the pressure generated by the first turbocharger 07 can also be determined qualitatively and/or quantitatively by means of a mathematical function, or some other means.

### LIST OF REFERENCE SYMBOLS

01 diesel engine
02 diesel tank
03 water cooler
04 fluid reservoir
05
06 exhaust flow
07 first turbocharger
08 second turbocharger
09 air filter
10
11 difference pressure switch
12 first air cooler
13 second air cooler
14 intake regulator
15
16 blow-off device
17 screw compressor
18 pressure reservoir
19 temperature sensor
20
21 intake line
22 non-return valve
23 fine separator
24 oil filter
25
26 oil temperature regulator
27 oil cooler
28 non-return valve
29 pressure sensor
30
31 safety valve
32 removal tap
33 pressure-sustaining valve
34 pressure limiter
35
36 proportional regulator
37 pressure sensor
38 quick-action stop valve
39 bypass valve
40
41 non-return valve
42 relief valve
43 control valve
44
45
46
47
48
49
50
51 first characteristic curve
52 second characteristic curve

1. A method for controlling the operation of a gas or air compressor unit, comprising an internal combustion engine, a first turbocharger for generating compressed air for the internal combustion engine and a second turbocharger for generating compressed air, wherein the first turbocharger and the second turbocharger are disposed in an exhaust flow path of the internal combustion engine, wherein the method comprises the following steps:
monitoring a pressure of the compressed air generated by the first turbocharger during an operating state of the compressor unit; and
changing the operating state of the compressor unit when the monitored pressure falls below a previously determined value.

2. The method according to claim 1, characterized in that, in the monitored operating state, the air compressed by the second turbocharger is conducted to a main compressor powered by the internal combustion engine, which compresses the compressed air.

3. The method according to claim 2, characterized in that the step for changing the operating state furthermore comprises a closing of a feed of intake air to the main compressor.

4. The method according to claim 3, characterized in that the step for changing the operating state furthermore comprises an activation of an intake regulator.

5. The method according to claim 1, characterized in that a volume subjected to compressed air by the second turbocharger can be opened by opening a blow-off device, wherein the method comprises the following steps:
control of the blow-off device via a pressure regulator;
monitoring of a control pressure caused by a pressure regulator; and
changing of the operating state when the control pressure exceeds a previously determined maximum value when in the operating state.

6. The method according to claim 1, characterized in that the previously determined value is a function of a rotational rate of the internal combustion engine.

7. The method according to claim 1, characterized in that the changing of the operating state comprises a lowering of the rotational rate of the internal combustion engine from an operating rotational rate to an idling rotational rate of the internal combustion engine.

8. The method according to claim 7, characterized in that the changing of the operating state furthermore comprises a shutting off of the internal combustion engine.

9. The method according to claim 1, characterized in that the exhaust flow of the internal combustion engine flows first through the first turbocharger and subsequently through the second turbocharger.

10. The method according to claim 1, characterized in that a pressure generated by the second turbocharger is not measured.

11. The method according to claim 1, characterized in that the measurement values of the pressure generated by the first turbocharger represent monitoring data, which are transmitted to a superordinate compressor control system.

12. The method according to claim 11, characterized in that the monitoring data form an actual-characteristic, which is compared in the superordinate compressor control system with a predefined target-characteristic.

13. The method according to claim 12, characterized in that the changing of the operating state of the compressor unit first occurs when the actual-characteristic deviates from the target-characteristic by more than a predefined value.

14. A compressor unit for compressing air or gas, comprising the following components:
an internal combustion engine;
a first turbocharger disposed in an exhaust flow path of the internal combustion engine, having an air outlet in the flow connection with the internal combustion engine;
a second turbocharger disposed in the exhaust flow path of the internal combustion engine having an air outlet for generating compressed air;
a pressure sensor coupled to a flow path of the compressed air generated by the first turbocharger; and
a control unit connected to the pressure sensor, which is configured to change an operating state of the compressor unit when the pressure monitored by the pressure sensor falls below a previously determined value.
